(19) United States
(12) Patent Application Publication
(10) Pub. No.: US 2016/0176375 A1
(43) Pub. Date: Jun. 23, 2016

(54) REMOTE AUTOMATIC CLOSURE OF POWER WINDOWS, SUN ROOF AND CONVERTIBLE TOP

(71) Applicant: Continental Automotive Systems, Inc., Auburn Hills, MI (US)

(72) Inventors: Zachary Joseph Bolton, Birmingham, MI (US); Ralf Wagner, Immenstaad (DE); Juergen Vetter, Salem (DE)

(21) Appl. No.: 14/576,460

(22) Filed: Dec. 19, 2014

(51) Int. Cl. B60R 21/015; G05D 3/00

(52) U.S. Cl. CPC B60R 21/01538; G05D 3/00; B60R 2021/01286

(57) ABSTRACT

A precipitation detector, a single actuation of a switch or the departure of a drive triggers operation of a motor to close a window, sun roof or convertible top. In order to prevent injury to a person who might be nearby the vehicle when the motor operates, humanoid detectors monitor the area around a vehicle and detect whether a person is nearby and who could thus be injured by a computer-controlled operation of the window, sun roof or top. The operation of a power window, sun roof or convertible top is stopped or inhibited when a person is detected near the vehicle in order to prevent the person from being injured by the closure of with window, sun roof or top.

### BACKGROUND

Many vehicles are manufactured with a power-operable sunroof, a convertible top or power windows. While these devices can make driving a somewhat more enjoyable, forgetting to close a window, a convertible top or sunroof after the car is parked and the driver leaves can be problematic, especially when it rains. Even when a driver remembers to close a sunroof or convertible top, actually closing them typically requires a driver or operator to physically hold or depress a button or switch to reduce the likelihood of injury caused by closing a sunroof or convertible top. Holding a button or switch closed can certainly provide safety advantages but it also requires time for someone to be in the car or hold a key fob near the car to close the top or sunroof. An apparatus and method for safely closing a window, power sunroof or convertible top automatically without having to maintain a switch closure would be an improvement over the prior art. Such a system would be useful when precipitation is detected and the windows and top need to be closed, when a driver walks away from a vehicle with the windows open or top open or when a driver is hurried and simply wants to close the window, sun roof or top without having to hold a button closed.

### BRIEF DESCRIPTION OF THE FIGURES

FIG. 1 is a side view of an automobile with a convertible top shown in the open position;

FIG. 2 is a top view of an automobile with a power-operated sunroof with the sunroof in the open position;

FIG. 3 is a block diagram of an apparatus for automatically closing a vehicle's window, sunroof or convertible top; and

FIG. 4 depicts steps of a method for enabling the automatic closure of a vehicle's window, sunroof or convertible top.

### DETAILED DESCRIPTION

As used herein, the term, “convertible” refers to a type of automobile that has a top for the passenger compartment, which is removed or opened by lifting and stowing the top in a trunk-like storage container located behind the passenger compartment. The top is moved by an electric motor. The motor's direction and the opening and closing of a window, sun roof or convertible top, is determined by the voltage polarity provided to the motor.

The term, “humanoid” means having human form or characteristics. A person is of course humanoid. A person's hands, arms, fingers, legs, neck and head are also considered to be humanoid. A human, a hand, an arm, fingers, legs, feet, neck and head all have shapes that are humanoid. They also have surface temperatures and emit thermal energy at rates that are humanoid.

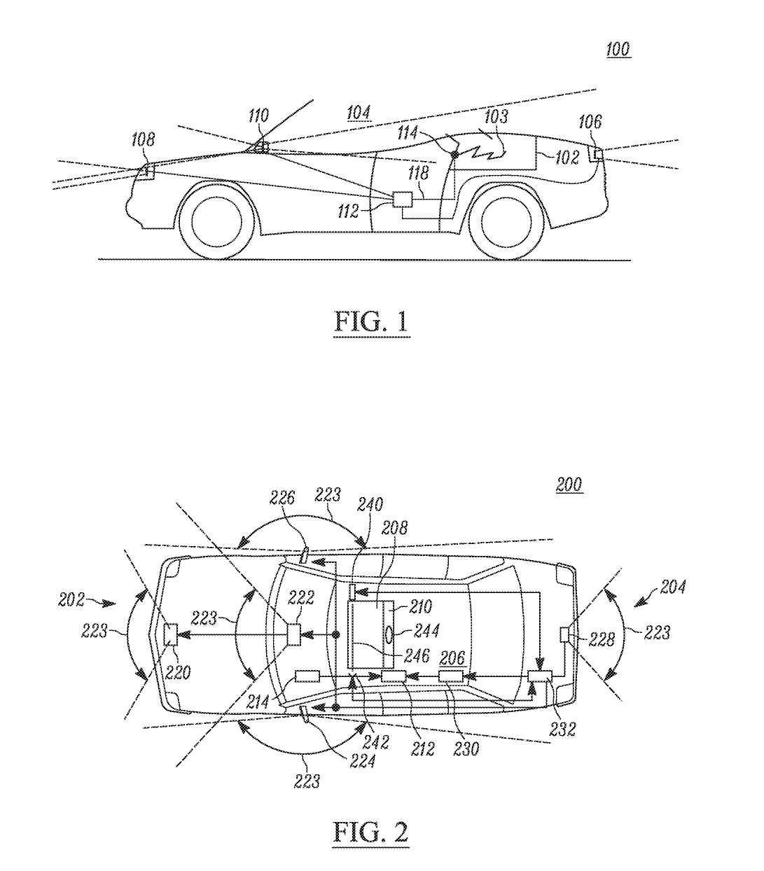

FIG. 1 is a side view of a motor vehicle (an automobile) 100 having a convertible top 103, depicted in the figure as being open and stored in a compartment 102 from which the top 103 is extended by a motor to cover the passenger compartment 104. The vehicle 100 is also provided with several humanoid detectors 106, 108 and 110, arranged to detect humanoid objects and shapes within a predetermined distance of the vehicle 100 or within a predetermined distance of a window, a convertible top or, in the case of the vehicle shown in FIG. 2, a sunroof. Each humanoid detector provides an output signal, which is processed as described below to determine whether someone is too close to the vehicle to safely operate a motor to close the top automatically, i.e., under the control of a processor, not a person.

Detecting humans and humanoids is well known. See for example, Enzweiler and Gavrila, “Monocular Pedestrian Detection: Survey and Experiment” IEEE Transactions on Pattern Analysis and Machine Intelligence,” Volume 31, No. 12, December 2009, page 2179-2195, the contents of which are incorporated herein by reference. Monitoring the area around a vehicle using multiple cameras is also well known. See for example Zhang et al, “A Surround View Camera Solution for Embedded Systems,” The CVPR 2014 workshop paper provided by the Computer Vision Foundation, available online through the IEEE Xplore data base, the contents of which are incorporated herein by reference.

In FIG. 1, humanoid detectors 106, 108, 110 are connected to a motor controller 112. The motor controller 112 is coupled to a D.C. motor 114, which is coupled to the convertible top through a transmission, omitted for clarity.

The top 103 is opened and closed responsive to signals 118 that the motor 114 receives from the motor controller 112. The open and close signals 118 received by the motor are simply voltages of different polarity, which as is well known, cause the motor 114 to rotate in different directions. The motor 114 is operated in each direction by corresponding signals received by the motor from the controller 112. As described more fully below, the motor controller 112 provides a “close” signal to the motor 114, i.e., a voltage, the polarity of which causes the motor to rotate in a direction that closes the top, responsive to a signal that the motor controller 112 receives from the actuation of a momentary switch, i.e., a switch that has electrical contacts that are either opened or closed by a direct manipulation of a human.

FIG. 2 is a top view of a vehicle 200 having a front end 202, a rear end 204, a top 206 and a sunroof 208. The sunroof 208 is provided with an electrically operable sunroof cover 210. The cover 210 is opened and closed by a D.C. motor 212. It is electrically coupled to a dash-board mounted momentary switch 214, the actuation of which by a person opens and closes the sunroof 208. The motor 212 is coupled to and driven by a motor controller 230, which is in turn coupled to a processor 232.

In a preferred embodiment, humanoid detectors are embodied as digital cameras having wide viewing angles (wide fields of view) that overlap. Two front-facing cameras 220, 222 with overlapping fields of view 223 capture images of objects in front of the vehicle 200. Two side-facing wide-angle side cameras 224 and 226 attached to rear-view mirrors on the left and right sides of the vehicle 200 monitor the left and right sides of the vehicle 200. A rear facing camera 228 above or below the license plate (not visible) monitors the area behind the vehicle 200. The cameras, which are digital cameras, capture images of objects within their respective fields of view 223.

The cameras 220, 226, 224 and 226 and a motor controller 230 for the sunroof motor 212 are coupled to a processor 232 via a conventional vehicle bus which runs throughout the vehicle 200. The bus is preferably a controller area network (CAN) bus, well known in the art and omitted from FIG. 2 for brevity.

In a first embodiment, optical cameras capture images of visible objects around or near the vehicle 200 and provide digital data representing those images to the processor 232. The processor 232 executes program instructions by which the captured images are processed to determine whether they include parts of a human being's body, humanoid shapes, and thus indicate the presence of a human near the vehicle 200 and hence near the sunroof door 210.

In an alternate second embodiment, a laser 240 and laser detector 242 are mounted inside the vehicle passenger compartment and positioned near the front edge 244 of the sunroof 208. The laser and detector 240, 242 respectively detect an object in the path of the sunroof cover 210 when the beam 246 from the laser is interrupted. When the beam 246 is interrupted, the sensor 242 sends a signal (or stops sending a signal) to the processor 232. The signal (or absence) of the laser beam 246 as detected by the sensor 242 notifies the processor 232 of an object in the pathway of the sunroof cover 210.

Regardless of how a human or humanoid shape is detected, when a person or humanoid shape is detected near the vehicle or in the pathway of a motor-drive window, motor-driven sun roof or motor-driven convertible top, the processor controlling the motor that operates the window, sun roof or convertible top is programmed to inhibit operation of such a motor in order to protect a human from possible injury that could be caused by an automatic closure of the sunroof, i.e., a drive motor operation, which is started by the processor on receipt of a closure signal and thereafter controlled exclusively by the processor, without human intervention or control, until the window, sun roof or convertible top is fully and completely closed.

In the absence of a detected humanoid shape, program instructions executed a processor cause it to monitor a sunroof control switch, a precipitation detector or a passive entry system for signals indicating that the windows, top or sun roof should be closed. When such a signal is received, the processor sends a signal to the motor controller, which causes the motor controller to operate the window motor, sun roof motor or convertible top motor continuously, until the sunroof is fully closed. Humanoid detectors are monitored continuously during operation of a closure motor and if a humanoid is subsequently detected, the processor stops the motor until the motor can be operated safely, i.e., without someone being around the vehicle where they might be injured by the automatic closure.

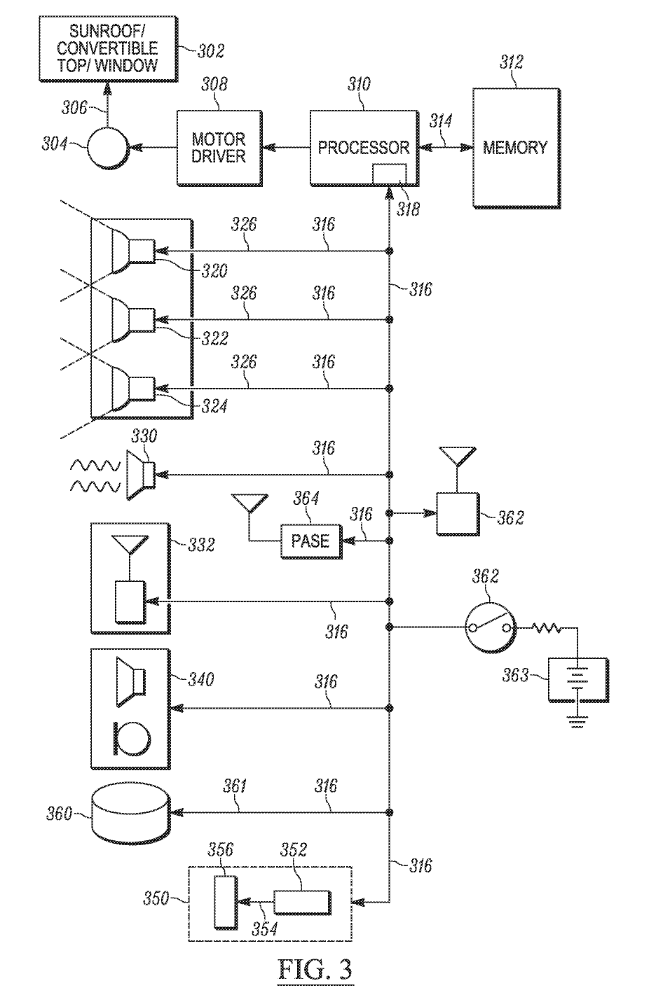

FIG. 3 is a block diagram of an apparatus for automatically closing a vehicle's window, sunroof or convertible top. The apparatus 300 comprises a sunroof, a convertible top or power operated window 302 driven (operated by) a direct current (D.C.) motor 304 coupled to the sunroof, top or window through a conventional transmission 306.

The motor 304, which is of course reversible, is provided electrical energy by a motor driver 308. The motor driver 308 reverses the polarity of the voltage provided to the motor 304 in order to change the direction of the motor's rotation. The motor driver 308 is controlled by a conventional processor 310, which is coupled to a non-transitory memory device 312 by a conventional bus 314.

As used herein, the term “bus” includes a set of electrically-parallel conductors in a computer system and which form a main transmission path. The address/control/data bus 314 that extend between the processor 310 and memory device 312 are well known. Further description of them is therefore omitted for brevity.

The processor 310 is coupled to a second, vehicle bus 316 via a bus interface 318. In a preferred embodiment, the vehicle bus 316 is a controller area network (CAN) bus, well known to those of ordinary skill in the automotive art as a vehicle bus designed to allow microcontrollers and microprocessors to communicate with various peripheral devices using a message-based protocol. Since the CAN. bus is well known to those of ordinary skill in the art, further description of it and its protocol is omitted for brevity.

Still referring to FIG. 3, a plurality of humanoid detectors are coupled to the processor 310 via the CAN bus 316. The humanoid detectors essentially provide signals to the processor, i.e., a humanoid detected output signal, which when analyzed provide an indication that a human is near the vehicle. The humanoid detectors include digital optical cameras 320 322 and 324, which are attached to the vehicle and mounted to enable the cameras to capture images of areas around the vehicle and within a predetermined distance of the vehicle. Digital data 326 representing optical images (produced by light having wavelengths visible to humans) captured by the cameras 330, 332 and 334 are provided to the processor via digital data 326 that is transmitted from the cameras to the processor over the bus 316.

Executable instructions stored in the non-transitory memory device 312 cause the processor 310 to analyze captured images for patterns, and shapes of objects, the sizes and orientations of which are consistent with a human body and its appendages (fingers, hands, arms, feet, legs, neck and head) within a predetermined distance of the vehicle. Data representing images that include humanoid shapes in them can thus be considered humanoid-detected output signals. The predetermined distance is a design choice and in a first preferred embodiment is about 10-12 feet.

In addition to optical cameras, an infrared detector or infrared camera 330 is also considered to be a humanoid detector. Thermal images, including both emitted heat energy and surface temperature of an object in an image are captured by the infrared cameras 330. Data representing those images and heat-related information are provided to the processor 310 for analysis via the bus 316. Data representing such images can also be considered humanoid-detected output signals.

In a preferred embodiment, an infrared camera 330 is used in combination with the optical cameras. Optical and thermal images of objects within a predetermined distance and are provided to the processor 310 and together provide a more accurate indication of a person near the vehicle.

Short-range wide-band radar is well known in the art. Such radar can also be used to detect objects and humanoid shapes near the vehicle.

In FIG. 3, a radar transponder 332 transmits and receives short-range wide-band radar pulses, which are used to detect objects within a few feet of the vehicle. Signals from the transponder 332 that would indicate the presence of an object near the vehicle are thus provided to the processor 310 via the bus 316 and are considered to be humanoid-detected output signals.

Ultrasonic waves can also be used to detect humanoid shapes, as is well known. In FIG. 3, an ultrasound detector 340, also coupled to the processor 310 and via the bus 316, sends signals, which when processed indicate the shapes of objects including humans near the vehicle. Such signals are considered to be humanoid-detected output signals.

A laser detector 350 comprising a laser 352 and laser beam detector 356 is also coupled to the processor 310 via the bus 316. A laser beam 354 detected by the detector 356 generates a signal from the detector 356, which is provided to the processor 310. When the beam is interrupted, the loss of signal to the processor is interrupted as being caused by an object near the vehicle or in the pathway of a sunroof, power window or convertible top.

A WI-FI/Bluetooth detector 362 within the passenger compartment is configured to detect either WI-FI (I.E.E.E. 802.11-compatible signals) cellular or Bluetooth radio frequency signals within the passenger compartment and provide a signal to the processor 310 via the bus 316 that indicates the presence of a corresponding device inside the passenger compartment. The detection of such a signal is considered to indicate the presence of someone in the vehicle or a lost or forgotten phone, in which case closure of a top, window or sunroof can be effectuated or prevented.

Regardless of how a humanoid shape is detected, the detected presence of a human or humanoid shape around or near the vehicle causes the processor 310 to inhibit or stop the operation of a motor 304 that operates to close a window, convertible top or sun roof 302. Conversely, a window, convertible top or sun roof 302 can be closed automatically when no one is around the vehicle. The automatic closure of a window, convertible top or sun roof 302, by which is meant, start-up and continuous operation of a motor 304 to close them, is effectuated by signal received by the processor 310 over the bus 316 from one or more of a precipitation detector, a momentary switch or a PASE system.

Still referring to FIG. 3, a precipitation detector 360 in the passenger compartment or outside thereof provides a precipitation-detected output signal 361 to the processor 310, which indicates the presence of precipitation in the passenger compartment. Program instructions in the non-transitory memory device 312 cause the processor 310 recognize a precipitation detected signal 361 and activate a motor 304 required to close windows, a sunroof or convertible top 302.

A prior art passive start and entry system (PASE) 364 is also coupled to the bus 316. As is well known, the PASE system 364 comprises a radio frequency receiver, which can receive a window closure signal from a key fob but which can also detect the departure and approach of a keyless entry key fob by a weakening radio frequency signal. It can also detect the approach of a key fob. The receipt of a window closure signal from a key fob, a departure or approach of a key fob, and presumably the driver as indicated by signals provided to the processor 310, cause the processor 310 to either lock the doors or unlock the doors depending on whether the key fob is moving away from the vehicle or approaching the vehicle. Such signals are also used by the processor to selectively close a window, sunroof or convertible top 302 by actuating the corresponding drive motor 304.

Program instructions inside the memory device 312 cause the processor 310 to recognize from the PASE system, whether a key fob is moving toward or away from the vehicle. If the key fob is moving away from the vehicle and the sunroof or window or convertible top are in an open position, program instructions in the memory device 312 cause the motor driver 308 to drive the motor 304 in a direction that closes the window, sunroof or top in the absence of a humanoid or human detected by one of the aforementioned sensors.

In addition to the precipitation detector and PASE system, a momentary switch 362, typically in the vehicle dash board, provides a signal 363 to the processor, which indicates the switch's closure. Program instructions in the memory device 312 cause the processor to operate the motor 304 to close the window, sun roof or convertible top 302 responsive to receipt of the switch closure signal 363.

The automatic closure of a window, sun roof or convertible top 302 after a closure signal is received by a processor, is performed if there is no one around the vehicle who could be injured by the computer-controlled operation of a motor 304 that operates them.

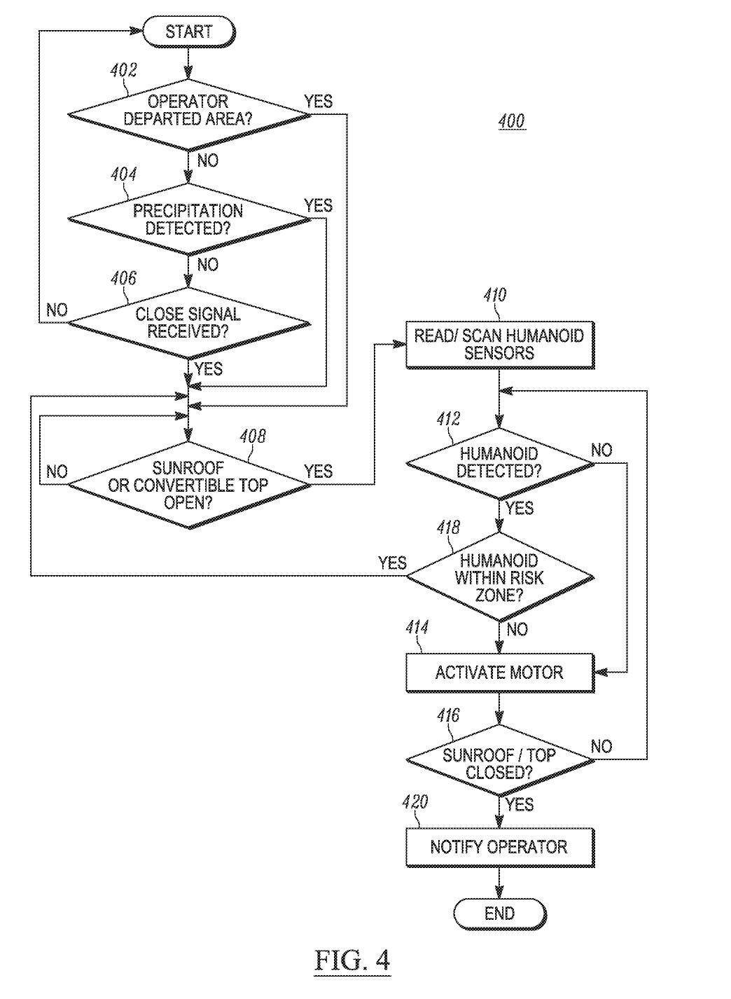

FIG. 4 depicts steps of a method 400 for automatically closing a vehicle's window, sunroof or convertible top 302 responsive to the receipt of a closure signal, but subject to the absence of a person who is too close to the vehicle. As shown in FIG. 4, a signal to automatically close a window, sun roof or convertible top (closure signal) can come from at least three different sources or events. At step 402, a signal to close the top, window or sunroof is generated when a passive start and entry system (PASE) detects that an operator (key fob) has departed the area around the vehicle. A closure signal will also be generated at step 404 if precipitation is detected by a precipitation detector, such as the one shown in FIG. 3 and described above. A closure signal will also be generated at step 406 if a signal is received from a wireless key fob or a dashboard push button.

After a closure signal is received, a test is performed at step 408 to determine whether a sunroof, convertible top or window have been left open or partially open. If the result of the test at step 408 is positive or true, the method proceeds to step 410 where signals from various humanoid detectors are queried to determine whether signals exist, which indicate the presence of a human or humanoid shape near the vehicle.

At step 412, a test is performed on signals from the sensors to determine whether those signals indicate the presence of a humanoid. Such a test includes pattern matching images obtained from optical cameras, ultrasound signals, short-range, wide-band radar and/or measurement of surface temperatures and heat emitted from an object. If no humanoid has been detected a motor that controls a window, sun roof or top is activated at step 414 and kept running by the execution of a loop comprising steps 412, 418 and 414, until a determination is made at step 416 that the window, sun roof or top are completely closed.

Referring again to step 412, regardless of which closure signal is generated, if a humanoid has been detected, a second test is performed to determine whether the humanoid is within a risk or danger zone, the dimensions of which are design choice but preferably within about 10-12 feet of the vehicle. The interruption of a laser beam in the pathway of a sunroof is highly indicative that a person or appendage is in the pathway of a window, sun roof or convertible top.

If a humanoid is detected at step 418 as being within a predetermined risk zone, the program/method returns to step 408. The method continues looping through steps 408, 410, 412 and 418 until the human or humanoid object is outside the risk zone.

If on the other hand the test at step 418 is negative, the motor that operates a window, sun roof or top is activated at step 414 and the method loops through step 416-412 repeated until the window, sun roof or top is closed.

At step 416, when the sunroof, window or top is closed, a message is sent to the operator of the vehicle at step 420, indicating that the window, sunroof or top has been closed. The form of such a message is a design choice, examples of which include text message to a telephone, an e-mail, a horn blast or headlight blink.

For purposes of claim construction, monitoring the area around a vehicle for humans and humanoid shapes using sensors such as those described above is considered herein to be an electronic surveillance. The safe, automatic closure of a window, sun roof or convertible top is realized by electronically and continuously surveilling (continuously monitoring) the area around and near a vehicle for the presence of a human using one or more humanoid detectors. If no one is detected around a vehicle, as indicated by humanoid-detected signals from detectors, or lack thereof, the windows, sun roof and/or convertible top can be closed automatically when precipitation is detected, the driver has left the vehicle or on a single actuation of a switch. A motor that drives a window, sun roof or convertible top is stopped when a person is detected as being nearby. It is thus possible to automatically close a window, sunroof or convertible top to prevent damage to the vehicle if an operator inadvertently forgets to close them or if ambient conditions are such that a closure is appropriate.

The foregoing description is for purposes of illustration only. The true scope is set forth in the following claims.

What is claimed is:

1. An apparatus for automatically closing a vehicle's window, sun roof or convertible top, the apparatus comprising:
a motor, operatively coupled to move the window, sun roof or convertible top between open and closed positions responsive to a signal received by the motor from a motor controller;
a humanoid detector, configured to detect at least part of a human within a predetermined distance of at least one of the window, sun roof and convertible top of the vehicle and thereafter provide a humanoid-detected output signal, which indicates detection of at least part of a human near the vehicle; and
a motor controller coupled to the motor and coupled to the humanoid detector, the motor controller configured to provide a close signal to the motor responsive to a single closure signal for a window, sun roof or convertible top, and configured to inhibit operation of the motor responsive to the motor controller's receipt of the humanoid-detected signal from the humanoid detector.

2. The apparatus of claim 1, further comprising a radio frequency receiver coupled to the motor controller, the receiver being configured to receive a radio frequency signal that carries the closure signal and being additionally configured to provide a received closure signal to the motor controller.

3. The apparatus of claim 1, wherein the humanoid detector comprises a plurality of cameras attached to the vehicle, the plurality of cameras being configured to capture optical images of areas within the predetermined distance and to provide data representing said optical images to the motor controller, and wherein the motor controller is configured to, receive data representing said images from the plurality of optical cameras and recognize humanoid objects in said images and, inhibit operation of the motor responsive to recognition of a humanoid object in an image.

4. The apparatus of claim 1, wherein the predetermined distance is less than about twelve (12) feet.

5. The apparatus of claim 1, wherein said motor controller is a processor and a memory device storing program instructions, which when executed cause the processor to recognize shapes of humanoid objects in images using pattern recognition.

6. The apparatus of claim 3, wherein said optical images from the plurality of cameras comprise thermal images, which comprise thermal indications of a temperature of an object in an image and wherein said motor controller is a processor and a memory device storing program instructions, which when executed cause the processor to recognize shapes of humanoid objects in thermal images using pattern recognition and surface temperatures of objects in said image

7. The apparatus of claim 1, wherein the humanoid detector comprises a short-range wide-band radar configured to detect an object within a predetermined distance of the vehicle.

8. The apparatus of claim 1, wherein the humanoid detector comprises a short-range wide-band radar transponder configured to detect an object within the predetermined distance of the vehicle.

9. The apparatus of claim 1, wherein the humanoid detector comprises an ultrasonic transponder configured to detect an object within the predetermined distance of the vehicle

10. The apparatus of claim 1, wherein the motor controller comprises a processor and wherein the apparatus further comprises a precipitation detector coupled to the processor, the precipitation detector having an output, which provides a precipitation-detected signal indicating the presence of atmospheric precipitation, the precipitation-detected signal being provided to the processor, which is additionally configured to provide a close signal to the motor responsive to receipt of the precipitation-detected signal and absence of the humanoid-detected output signal from the humanoid detector.

11. The apparatus of claim 1, further comprising a passive start and entry system, the passive start and entry system being configured to selectively provide a close signal to the motor controller upon a determination that the vehicle is unattended.

12. A method of automatically closing a vehicle's window, sun roof or convertible top responsive to receipt of a closure signal for the window, sun roof or convertible top, the method comprising:
when the window, sun roof or convertible top is in an open position, electronically surveilling a predetermined area around the exterior of the vehicle with a humanoid detector configured to provide first and second output signals, the first output signal indicating that at least part of a humanoid shape is detected within the predetermined area, the second output signal indicating that no humanoid shape is detected within the predetermined area;
receiving a closure signal;
actuating the closure mechanism for the window, sun roof or convertible top, responsive to receipt of the closure signal and receipt of the second output signal; and
inhibiting the closure mechanism operation responsive to receipt of the first output signal.

13. The method of claim 12, wherein electronically surveilling a predetermined area is performed by a plurality of optical cameras attached to the vehicle and which capture images of objects within a predetermined distance of the vehicle and provide data representing said images to a motor controller configured to receive data representing images captured by optical cameras, recognize humanoid objects in said images and provide an output signal responsive to recognition of a humanoid object in an image.

14. The apparatus of claim 12, wherein the step of electronically surveilling a predetermined area is performed by a plurality of thermal imaging cameras configured to provide indications of a surface temperature of an object in said thermal images and wherein the step of inhibiting the motor operation comprises inhibiting the motor upon the detection of an object having a surface temperature substantially equal to the body temperature of a human.

15. The method of claim 12, wherein the step of electronically surveilling a predetermined area is performed by a short-range wide-band radar transponder configured to detect an object within a predetermined distance of the vehicle.

16. The method of claim 12, wherein the step of electronically surveilling a predetermined area is performed by an ultrasonic transponder configured to detect an object within a predetermined distance of the vehicle

17. The method of claim 12, further comprising:
detecting precipitation by a precipitation detector;
providing the closure signal responsive to the detection of precipitation; and
wherein steps of electronically surveilling and actuating the closure mechanism are performed after the step of detecting precipitation.

18. The method of claim 12, further comprising:
detecting movement of a vehicle operator away from the vehicle by a predetermined distance using a passive start and entry system, said movement of the vehicle operator away from the vehicle by the predetermined distance causing performance of the electronically surveilling, actuating a motor and inhibiting steps of the method.

19. The method of claim 12, further comprising:
sending a notification message to an operator of the vehicle, the notification message indicating that the vehicle's window, sun roof or convertible top has been automatically closed.
